(19) United States
(12) Patent Application Publication
(10) Pub. No.: US 2007/0214297 A1
(43) Pub. Date: Sep. 13, 2007

(54) Worktop and Furniture Incorporating a Worktop

(76) Inventor: David Gilbert, Surrey (GB)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/572,618

(22) PCT Filed: Jul. 25, 2005
(86) PCT No.: PCT/GB05/02922

§ 371 Date: Jan. 24, 2007

(30) Foreign Application Priority Data
Jul. 24, 2004 (GB) 0416586.6

(51) Int. Cl. G06F 13/00

(52) U.S. Cl. 710/100

(57) ABSTRACT

A worktop comprises a first surface and second surface spaced apart by a face to define the thickness of the worktop. The worktop is provided with a compartment towards the rear which can receive a standard computer base unit. A source of mains power is provided to this compartment by means of cad e, and further connections to the base unit within the compartment allow for the standard peripherals, namely a display, a keyboard and a mouse to be attached. The worktop and associated compartment are supported on legs or other suitable supports which may be movable so that the worktop can be raised or lowered. The worktop has at least one peripheral component (20), e.g. a DVD, embedded in its thickness which is accessible at the front of the worktop. In order that the base unit of the computer can communicate with the component, a conversion module (31) is provided which converts the USB signals at the base unit to IDE/EIDE signals received by or transmitted from the component.

The present invention relates worktops and furniture incorporating worktops and particularly to furniture which house all or parts of a computer system and/or peripheral devices, controls and indicators associated therewith.

For the benefit of clarity the term worktop should be understood to mean any panel-like article which, in use, is horizontally disposed to provide a working surface and/or storage surface.

Also for the benefit of clarity a piece of furniture should be understood to mean any piece of furniture which may be moveable, such as, for example, a desk, or fixed, such as, for example, a kitchen cabinet.

The heart of a computer is the CPU (central processing unit—commonly a single integrated circuit) which is normally provided on a motherboard together with any closely associated circuit components and devices not requiring direct external access, such as memory, data buses, a basic input/output system (BIOS), a power supply (PSU), hard disk drive controllers and subsystems etc. There will also be a variety of different connections to and from the motherboard which ultimately provide the CPU with data to be processed so as to prove the computing power. Examples of items which may be connected include the various external peripherals which may be attached to the connectors usually provided externally of the base unit, being the container inside which the motherboard is mounted, such as a mouse, keyboard or touch sensitive pad, telephone line, network connection and/or scanner, and examples of peripherals which are commonly connected internally of the base unit directly to the motherboard include such devices as a DVD drive, a CDROM drive and hard disk drives. The CPU output may be manifested in a number of different ways, such as a display, a printer, network traffic and the like.

By the term “computer unit” is meant an integral arrangement which comprises a CPU (central processing unit—commonly a single integrated circuit), the motherboard on which it is mounted, and the various closely associated circuits/circuit components provided thereon, together with the peripherals traditionally provided internally of the base unit in which the motherboard is disposed, such as the CD or DVD drives and the hard disk drives.

The degree of integration of signal input and output devices with a CPU to form a computer unit is variable. Typically, separate external signal input devices such as keyboards and mice, and signal output devices such as displays and printers are plugged into a base unit, although they could be hard wired therein as part of the computer unit. Other signal input/output devices, such as modems, floppy disc drives and CDROM/DVD drives can also be external of the computer unit and coupled thereto, and indeed there are many of these external devices available today which can simply be connected to the base unit, and thus to the motherboard by means of a simple “Universal Serial Bus” or USB connection. Hard disk drives are almost invariably provided within the base unit and connected to the motherboard by means of a ribbon cable. Circuit components and devices not requiring direct external access, such as memory, a power supply, fan, are also normally hard wired to the motherboard within the computer unit.

The combination of a “computer unit” with externally coupled devices will be referred to as a “computer system”.

The visibility and portability of normal computer units and computer systems, and the accessibility of the CPUs and memory therewithin, make theft relatively easy. The normal steel case traditionally used in the manufacture of the base unit is functional rather than aesthetic.

Computer systems have become a common feature in many environments, including the majority of offices and many homes. The need to couple various external units to a computer unit to form what is, essentially, a single computer system almost inevitably leads to a tangle of wires, which is undesirable and not aesthetically pleasing. It becomes difficult to check and alter or replace connections between the different units, reliability and speed of operation of the system could be reduced, and when the wires trail over the floor, personal safety considerations come into play, together with the risk of damage to the wires themselves.

It is known to provide computer desks which have oversized holes to accommodate a variety of cased computer units and printers, and work stations which are capable of holding a monitor, printer and cased computer unit—although if the latter is a tower unit it will often have to stand beside the desk or work station. The different complete units in their own cases are simply placed into respective locations and interconnected. Removal is correspondingly simple. At least some parts of the interconnecting wiring and/or the units in their cases are commonly externally visible.

It is also known to provide furniture which is adapted to accommodate parts of the computer system in a more integrated manner. European Patent Application No. 0 165 130 discloses a two pedestal desk in which (a) a CRT monitor is retractable into one pedestal through an aperture in the desk top, which aperture is then closed flush with the desk top; (b) a keyboard on a central shelf is concealed with not in use by a sliding shutter which then lies flush with, and locally completes, the desk top—the shutter terminates in a vertical hinged flap, and both flap and shutter are necessary to conceal the keyboard; (c) a printer is located within the other pedestal, with continuous paper from a basket beneath the pedestal entering the back of the pedestal and emerging through a slot in the desk top; (d) also within the other pedestal is an assembly (computer unit) comprising, inter alia, a CPU, memory, power supply unit (s), disc drives and a fan. As shown, it appears that this assembly is formed on an open sided drawer-like base which can be removed as an entity from the desk. Also as shown, the controls for movement of the monitor and the slots for the disc drives are always visible at the front of the respective pedestals, and the integrity of the desk top is destroyed by the apertures for paper and monitor. Even when it is not in use, it will be apparent that this is rather more than a simple desk.

U.S. Pat. No. 5,033,804 shows a computer desk in which the central portion of the top contains a concealable keyboard and flush monitor. This portion is located in a central box also containing a computer and power supply, and is rotatable relative to the box from a position flush with side portions of the worktop to a working position in which both monitor and keyboard are revealed. Other appliances such as a facsimile machine, copier and/or printer are located beneath doors in the side portions of the worktop. In this arrangement, the integrity of the desk top is destroyed both by the need to rotate the central portion and the need to access different appliances mounted below it, and it appears that the computer is a discrete (cased) unit. It also seems likely that the central box will be of a depth unusual in a simple desk.

Other computer desks are described in UK Patent Application Serial No. 2 281 692, International Patent application Serial No. WO/86/06575, U.S. Pat. No. 4,852,500 and U.S. Pat. No. 5,071,204. In each of these, the work top lacks integrity, and/or external computer controls remain visible, and/or they do not disguise the fact that they contain a computer system, and/or they do not disguise the fact that a computer unit is incorporated, and is thus easily removable, as an entire unit.

European Patent application No. 0 251 643 discloses a chair in which at least one arm incorporates an ergonomically designed keyboard which remains visible when not in use.

The fundamental difficulty with these various prior art devices is that they are all concerned with the problem of trying to integrate, most simply, a computer into a desk. It is clearly well known to strip the computer down to its essential components, namely the motherboard, the PSU, the hard disk drives and the Input/Output devices such as monitor, keyboard, mouse and the like, and then to try, as ergonomically as possible given the constraints of the furniture, to locate or embed all these components within the furniture in cavities or recesses, and then merely to link the various, now remotely disposed components together by traditional wiring fed through channels or passageways provided in the desk.

It is worth mentioning that while there may be methods of achieving this aim, and that some of these methods and the “computer-enabled” furniture resulting from the methods may be patentable, in general, none of the prior art documents is concerned with a piece of apparatus which on the one hand can be view as a convenient and useful upgrade of a standard base unit and which on the other hand overcomes the prevailing difficulty of remotely connecting the types of peripherals to the motherboard of a base unit which are traditionally provided internally thereof in standard computer manufacture. It is to be understood in this instance that the types of peripheral in question are CD-ROM drives, DVD drives, hard disk drives and the like.

Those skilled in the art will already be aware that these types of peripheral are already available to purchase as stand alone items for connection to standard base units via a USB interface cable, but it is only relatively recently, indeed in the last 10 years or so, that the USB interface has become widespread across such usually internally connected peripherals. Formerly, the connection of such peripherals was usually only achieved either internally through very short (less than 30 cm) ribbon cables provided with suitable connectors depending on which data interface standard was employed, e.g. Integrated Drive Electronics (IDE), Extended IDE (EIDE) or Small Computer Systems Interface (SCSI), or externally by means of a suitable expansion card provided in one of the expansion slots of the computer, and a suitable (but again short) cable between the peripheral and the connector on the expansion card.

Traditionally, so-called “external” peripheral components have been more expensive than internal peripheral components, not least because of the need to make external components more aesthetically pleasing, but in general nowadays, almost all external peripheral components are connected to a computer base unit by a conventional and now ubiquitous USB interface cable. USB has been widely adopted because it is simple, data transfer rates are reasonable, and furthermore and importantly there is no need for knowledge of master/slave nomination between peripherals as is required in the case of IDE/EIDE interfaces, or of the requirement for termination as is needed in SCSI connected peripherals.

Hence, for the simple computer user, the connection of an external peripheral nowadays presents no problem, and it is a simple matter of plugging the peripheral in and this then being immediately recognized by the software operating system loaded in the computer's memory.

However, it is surmised that there is still a need for the IDE, EIDE, and SCSI (and more recently Serial Advanced Technology Attachment (SATA) standards because they allow for the manufacture of incredibly cheap peripherals on account of manufacturing techniques which have been employed now for some 20 years or more. Such standards are hereinafter referred to as internal interface standards, whereas USB, and the more traditional serial and parallel connections fall to be considered as external interface standards.

It is worth mentioning at this stage that the cost of an external USB (version 2) interface hard disk drive is almost twice that of an internal IDE/EIDE hard disk drive of corresponding size, but as mentioned, these standards are limited in their application because of:
i. the short distances over which the signals can travel along IDE/EIDE and SCSI cables
ii. their comparative complexity in set up.

The above is equally true for CD-ROM drives, and the newer CD-RW, DVD-ROM, DVD−/+RW drives-internal devices are always significantly less expensive than their corresponding, USB-specified external counterparts.

It is accordingly an object of this invention to provide a piece of furniture which allows for computing functionality in that certain components are embedded within the furniture work surface, and which takes advantage of the relative inexpensiveness of internal drive components.

According to the present invention a worktop comprises a first surface and second surface spaced apart by a face to define the thickness of the worktop which has front and rear portions, said worktop being provided with a compartment towards the rear portion of suitable dimensions to receive a standard computer base unit, said worktop and associated cabinet being supported and optionally movable relative to said support, said worktop being provided with at least one peripheral component adapted for connection to a motherboard by means of an internal interface standard, said peripheral component being disposed in the front portion of the worktop between the first and second surfaces so as to be accessible to a user for removal, replacement or insertion of suitable media thereinto,

Characterized in that

A conversion module is embedded in the worktop proximate the peripheral component which is connected to said conversion module by means of a suitable internal interface connector, said conversion module acting to convert the signals received from the peripheral component from signals transmitted in accordance with an internal interface standard to signals transmitted in accordance with an external interface standard, said conversion module transmitting said external interface standard signals to the base unit disposed in the compartment towards the rear of the worktop.

Preferably, the conversion module include signal amplification circuitry which effectively amplifies the signals received from the peripheral component over the internal interface standard before converting these into signals in accordance with the external interface standard.

Preferably the internal interface standard is of the IDE type (including EIDE), and the external interface standard is of the USB type.

Preferably, the transmission of the external interface standard signals from the conversion module is effected by means of one or more wires, first ends of which are connected to the base unit, and second ends are connected to said conversion module.

Preferably, a source of power, independent of the source of power provided to the base unit, is provided to the conversion module.

Preferably, this source of power is a battery wired to the conversion module and embedded in the worktop proximate to said conversion module.

Most preferably, the component is a media drive having a slot at its front for receiving suitable user-insertable media, and further provided with a rear connector of an internal interface standard type, said rear connector being wired to the conversion module internally of the worktop.

Most preferably the component is a DVD drive.

Alternately, the peripheral component is a hard disk drive.

Most preferably, the peripheral component is embedded in the worktop in such a manner that the majority of the body of the peripheral component is concealed within the worktop excepting the front face of said peripheral component, which is preferably flush with the front face portion of the worktop.

Most preferably, the peripheral component, the accompanying conversion module to which it is attached, and the base unit are capable communicating bi-directionally in that data is received by the motherboard of the base unit, and transmitted therefrom ultimately to be received by the peripheral component. This arrangement is particularly useful where the peripheral component is a media storage device such as a CD-R, CD-RW, DVD−/+RW, or hard disk drive.

It is worth mentioning that the source of additional power in the form of a slimline battery of the type that are commonly included in mobile phones allows for ejection of media from the peripheral component even when the base unit has been switched off and/or disconnected from mains power-this feature can often prove invaluable.

Most preferably, the worktop front face also includes one or more further components which power switch control, and one or more lights, said further components being wired to the base unit by conventional manner.

The present invention will now be described by way of example, with reference to the following drawings, in which:

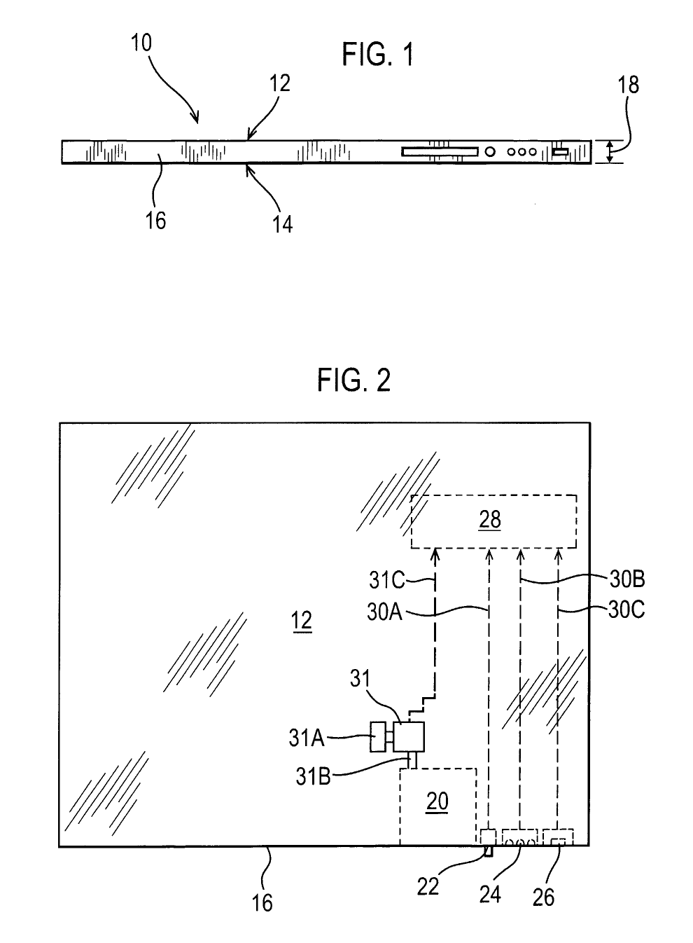

FIG. 1 is a drawing showing a front view of a worktop according to the present invention;

FIG. 2 is a drawing showing a plan view of the worktop of FIG. 1;

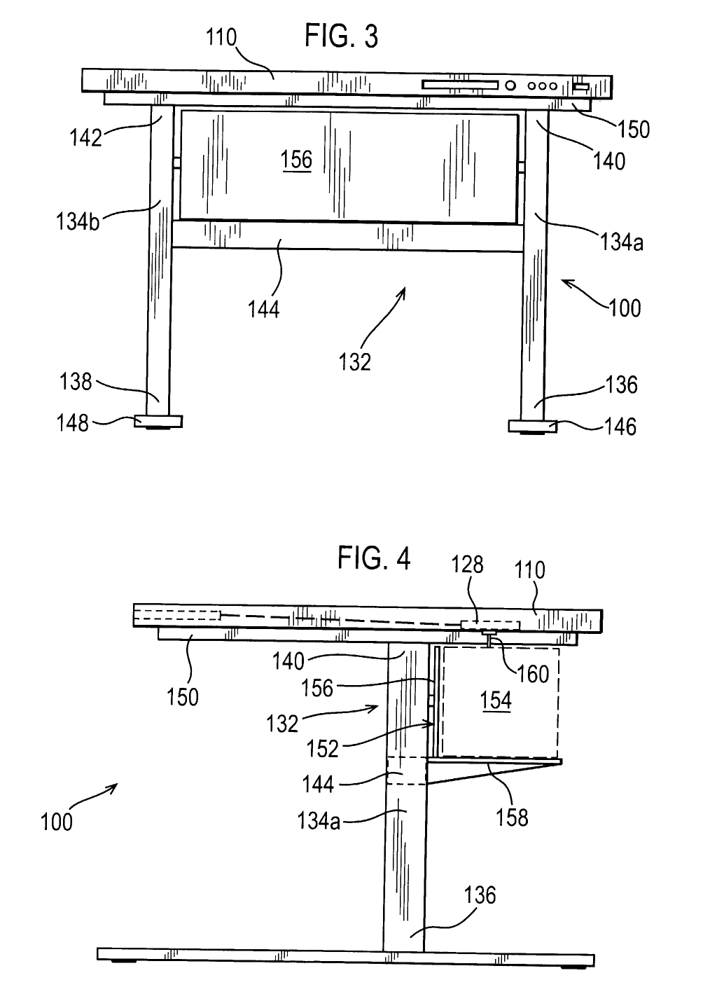

FIG. 3 is a drawing showing a front view of a desk comprising the worktop of FIGS. 1 and 2; and,

FIG. 4 is a drawing showing a side view of the desk of FIG. 3.

Referring to FIGS. 1 and 2, a worktop 10 comprises first and second surfaces 12 and 14, respectively, and a face 16. The first surface 12, which, in use, is a working surface, is spaced apart from the second surface 14, which, in use, is an under surface, by the face 16 to define the thickness 18 of the worktop 10.

The worktop 10 further comprises one or more parts of a computer system embedded therein. For convenience of user control, in this example the embedded computer parts are a CD/DVD drive 20, on/off switch 22, a set of three indicator lights 24, and a USB port 26. However, it will be appreciated that any number, or type, of computer parts may be embedded in the worktop. A worktop/computer interface 28 is also embedded in the worktop 10. Signal/power couplings 30A, 30B, 30C connect each of the additional components, such as the LEDs, the power switch, and the standard USB port with the worktop/computer interface 28 such that signals, either data or simply standard electrical signals, can be communicated therebetween. In this example the signal/power couplings are electrical connections. However, they may alternatively be optical connections. It is to be mentioned here that the interface 28 may most simply be a routing box which provides no other function except to provide a means whereby the wires embedded in the worktop may most easily be connected through to the motherboard within the base unit of a computer disposed underneath the worktop as hereinafter described. Indeed, in the case where the worktop is provided with wires with suitable connectors and of a suitable length for connection to the relevant connectors on the base unit, there may be no need whatsoever for the interface unit 28.

The embedded computer parts are disposed in the worktop such that they are contained within the thickness 18 thereof, to provide an uninterrupted first surface 12, thereby enhancing the working surface of the worktop while nevertheless providing easy and unhindered access to the peripheral components.

The computer parts and communication channels are embedded in the worktop by forming an inlay in an appropriate first surface, second surface or face of the worktop, such that the inlay is dimensioned to accommodate the relevant computer part or signal/power coupling. The inlay is formed using a router tool or other similar tool.

The embedded computer parts are suitably disposed in the worktop such that they facilitate user control of the computer system. For example, as shown in. the drawings, the CD/DVD drive 20, on/off switch 22, set of indicator lights 24, and USB port 26 are disposed such that their user interface are exposed on the face 16 of the worktop which, in normal operation, faces the user. The user is therefore provided with control of such user interface computer parts in a convenient position remote from other non embedded computer parts, such as for example the CPU, without any cables visible therebetween.

In accordance with the invention, a conversion module 31 and an associated slimline battery pack 31A (to which access may be provided through the under surface of the desk for replacement) are embedded in the worktop 12, and a standard internal interface connection 31B is provided between the drive 20 and said module 31. The particular electronics of the module are well within the knowledge of the skilled person and therefore not repeated here, suffice it to mention that the electronic circuitry of the conversion module not only converts the signals from an IDE/EIDE type received over the connection 31B to a USB-type standard, but also performs some amplification of these signals so that they may be adequately carried over the USB cable 31C which connects the module ideally to a suitable USB port provided on the interface 28, or possibly directly to one of the external USB ports on the base unit of the computer. To save on space, the external interface standard for communication between the module 31 and the base unit is of the mini-USB type.

In the case of USB port 26 provided in the front of the worktop (ideally for easy connection of the now popular USB memory sticks), a simple extension lead is all that is required, thus most simply allowing remote disposition of one of the external USB ports on the base unit.

Referring to FIGS. 3 and 4, a desk 100 comprises a worktop 110, as described above. Although FIGS. 3 and 4 show the worktop 110 utilised as a desktop, it will be appreciated that the worktop may be utilised for other applications such as, for example, in kitchens and laboratories.

The desk 100 further comprises a support structure 132 having a pair of upright members 134a and b, each having a lower end, 136 and 138, and an upper end, 140 and 142, respectively. The upright members 134a and b are spaced apart by a cross member 144.

Attached to each of the lower ends 136 and 138 are stabilising feet, 146 and 148, respectively. Attached to the upper ends, 140 and 142, is a supporting frame 150, which extends between the upright members 134a and 134b to support the worktop 110 therebetween. The worktop 110 is fixed to the supporting frame 150.

The desk further comprises screening means 152 for hiding additional non-embedded computer parts 154 of a computer system. The screening means 152 comprises a screen 156 and a shelf 158. The shelf 158 carries the additional non-embedded computer parts 154. The screen 156 is fixed to, and extends between, the upright members, 134a and 134b, such that, in normal use, the additional non-embedded computer parts 154 are hidden from view, as shown in FIG. 3.

An external signal/power coupling 160, couples the worktop/computer interface 128 and the non-embedded computer parts 154 and provides transmission of signals and power therebetween.

By virtue of the above, the reader will appreciate that the worktop, and more specifically the desk of which the worktop forms part, allows for the rapid and simple connection of a standard computer base unit which can be connected to the desk with little or no modification and immediately expanded by means of the additional drive embedded in the desk. Such facility is not demonstrated anywhere in the prior art.

In summary therefore, the invention provides a worktop comprising a first surface and second surface spaced apart by a face to define the thickness of the worktop. The worktop is provided with a compartment towards the rear which can receive a standard computer base unit. A source of mains power is provided to this compartment by means of cable, and further connections to the base unit within the compartment allow for the standard peripherals, namely a display, a keyboard and a mouse to be attached. The worktop and associated compartment are supported on legs or other suitable supports which may be movable so that the worktop can be raised or lowered. The worktop has at least one peripheral component, e.g. a DVD, embedded in its thickness which is accessible at the front of the worktop. In order that the base unit of the computer can communicate with the component, a conversion module is provided which converts the USB signals at the base unit to IDE/EIDE signals received by or transmitted from the component.

1. A worktop comprising a first surface and second surface spaced apart by a face to define the thickness of the worktop which has front and rear portions, said worktop being provided with a compartment towards the rear portion of suitable dimensions to receive a standard computer base unit, said worktop and associated compartment being supported and optionally movable relative to said support, said worktop having embedded therein at least one peripheral component adapted for connection to a motherboard disposed within the base unit, said peripheral component being provided with data communication means of an internal interface standard type, said peripheral component being disposed in the front portion of the worktop between the first and second surfaces so as to be accessible to a user for removal, replacement or insertion of suitable media thereinto,
characterized in that
a conversion module is embedded in the worktop proximate the peripheral component which is connected to said conversion module by means of a suitable internal interface connector, said conversion module acting to convert the signals received from the peripheral component from signals of an internal interface standard type to signals of an external interface standard type, said conversion module transmitting said external interface standard signals to the base unit disposed in the compartment towards the rear of the worktop.

2. A worktop according to claim 1 characterised in that the conversion module includes signal amplification circuitry which effectively amplifies the signals of an internal interface standard type before converting these into signals into those of an external interface standard type.

3. A worktop according to either claim 1 or claim 2 characterised in that the internal interface standard is of the IDE type, and the external interface standard is of the USB type.

4. A worktop according to any preceding claim characterised in that the transmission of the external interface standard signals from the conversion module is effected by means of one or more wires, first ends of which are connected to the base unit optionally via an interface unit, and second ends are connected to said conversion module.

5. A worktop according to any preceding claim characterised in that a source of power, independent of the source of power provided to the base unit, is provided to the conversion module.

6. A worktop according to claim 5 characterised in that the independent source of power is a battery wired to the conversion module and embedded in the worktop proximate to said conversion module.

7. A worktop according to any preceding claim characterised in that the peripheral component is a media drive having a slot at its front for receiving suitable user-insertable media, and further provided with a rear connector of an internal interface standard type, said rear connector being wired to the conversion module internally of the worktop.

8. A worktop according to claim 7 characterised in that the component is a DVD drive.

9. A worktop according to claim 7 characterised in that the peripheral component is a hard disk drive.

10. A worktop according to any preceding claim characterized in that the peripheral component is embedded in the worktop in such a manner that the majority of the body of the peripheral component is concealed within the worktop excepting the front face of said peripheral component, which is preferably flush with the front face portion of the worktop.

11. A worktop according to any preceding claim characterized in that the peripheral component, the accompanying conversion module to which it is attached, and the base unit are capable communicating bi-directionally in that data is received by the motherboard of the base unit, and transmitted therefrom ultimately to be received by the peripheral component.
